(19) United States
(12) Patent Application Publication
(10) Pub. No.: US 2010/0088268 A1
(43) Pub. Date: Apr. 8, 2010

(54) ENCRYPTION OF DATA FRAGMENTS IN A PEER-TO-PEER DATA BACKUP AND ARCHIVAL NETWORK

(75) Inventors: Steven J. Buller, Tucson, AZ (US); Richard C. Garrett, Oro Valley, AZ (US); Richard Hutzler, Corona de Tucson, AZ (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/244,764

(22) Filed: Oct. 2, 2008

(51) Int. Cl. G06F 17/30

(52) U.S. Cl. 707/609; 709/230

(57) ABSTRACT

Embodiments of the present invention address deficiencies of the art in respect to data backup and archival tools and provide a method, system and computer program product for securing fragments in a peer-to-peer data backup and archival network. In an embodiment of the invention, a method for securing fragments in a peer-to-peer data backup and archival network can include partitioning a file into multiple, different fragments in a byte stream for storage in a peer-to-peer data backup and archival network, encrypting each of the fragments in the byte stream individually, and storing the encrypted fragments for the byte stream in different peer hosts in the peer-to-peer data backup and archival network.

### REFERENCE TO CO-PENDING APPLICATIONS FOR PATENT

The present application is related to the following co-assigned U.S. patent Applications, which are expressly incorporated by reference herein:

U.S. application Ser. No. ______, entitled “DISPERSAL AND RETRIEVAL OF DATA FRAGMENTS IN A PEER-TO-PEER DATA BACKUP AND ARCHIVAL NETWORK” (docket no RPS920080058US1 (126U)), filed on Oct. 2, 2008.

U.S. application Ser. No. ______, entitled “PERIODIC SHUFFLING OF DATA FRAGMENTS IN A PEER-TO-PEER DATA BACKUP AND ARCHIVAL NETWORK” (docket no RPS920080059US1 (127U)), filed on Oct. 2, 2008.

### BACKGROUND OF THE INVENTION

1. Field of the Invention

The present invention relates to the field of data backup and archival tools and more particularly to data fragment dispersal about a computer communications network for data backup and archiving.

2. Description of the Related Art

The advent of personal computing revolutionized both the collection and generation of data in the personal and industrial environments. Prior to the widespread adoption of computing, data collection meant paper—lots of it. Data archival and retrieval referred to nothing more than the filing of paper in a filing cabinet indexed for relative ease of retrieval. As the volume of data grew, so too did the physical space requirements for filing cabinets. Data archives of more significant volume necessarily involved microfiche—photographs of data in order to reduce the physical space requirements of filing cabinets. Thus, the evolution of electronic data collection and storage literally saved the world from filing cabinet overpopulation.

The replacement of physical paper with electronic data, however, produced its own set of critical issues. First and foremost, data security remains of paramount importance. That is to say, since unlimited copies of data can be generated with the stroke of a key on a keyboard, it is imperative that only authorized individuals can access electronic data. Further, without data backup no one would rely upon electronic data lest a minor electro-mechanical malfunction of a disk drive result in the loss of critical information. Accordingly, two separate industries focused respectively upon data security and data backup and archival tools arose.

Traditional data backup and archival tools rely upon the principal of redundancy in placing copies of important data in different places so that a malfunction in one data storage medium is of minimal consequence. Advanced data backup and archival tools not only perform periodic backup operations, but also live backup operations in real time with the concurrent writing of data to multiple disk media. Of course, sophisticated data backup and archival tools also implement different degrees of data encryption and access control to effectuate correspondingly different level of data security.

Traditional data backup and archival tools can be expensive not only in the direct cost of software licensing, but also in respect to indirect costs like the establishment and maintenance of server farms supporting data backup and retrieval operations. Consequently, many users opt to outsource data backup and archiving to third party vendors who bear the burden of the expense of maintaining proper infrastructure. Engaging an outsourced provider of data backup and archival services, however, still can be very expensive and requires end users to acquire a certain degree of trust in the reliability and longevity of the provider. In particular, end users often lack the confidence that an outside vendor can maintain the security and confidentiality of data archived in storage controlled by the vendor.

Recognizing the difficulty of trusting third party vendors to perform data back and archival services, data backup and archival tools have been developed to disperse different files across many different servers such that the entirety of a data backup set is not entrusted within a single storage medium. As such, obtaining access to a given storage medium cannot result in corresponding access to the entire backup set. Even further, by utilizing existing servers in trusted server farms, a third party vendor providing this type of distributed data backup and archival service need not incur enormous infrastructure maintenance expense. Rather, the third party vendor need only maintain an index of where different files in a backup set can be located amongst a distributed grouping of servers. Even still, in as much as portions of the backup data set statically reside in the same location over time, data security remains partly exposed to compromise.

### BRIEF SUMMARY OF THE INVENTION

Embodiments of the present invention address deficiencies of the art in respect to data backup and archival tools and provide a novel and non-obvious method, system and computer program product for securing fragments in a peer-to-peer data backup and archival network. In an embodiment of the invention, a method for securing fragments in a peer-to-peer data backup and archival network can include partitioning a file into multiple, different fragments in a byte stream for storage in a peer-to-peer data backup and archival network, encrypting each of the fragments in the byte stream individually, and storing the encrypted fragments for the byte stream in different peer hosts in the peer-to-peer data backup and archival network.

In one aspect of the embodiment, the method also can include re-ordering each of the fragments prior to storing the encrypted fragments in the different peer hosts. Further, in another aspect of the embodiment, encrypting each of the fragments individually can include computing an encryption seed from a first fragment in the byte stream, and encrypting each of the fragments in the byte stream with the encryption seed. Yet further, in even another aspect of the embodiment, re-ordering each of the fragments prior to storing the encrypted fragments in the different peer hosts can include computing a random new position for each encrypted one of the fragments in an encrypted form of the byte stream according to a random number provided to a split algorithm. Finally, in even yet another aspect of the embodiment, encrypting each of the fragments in the byte stream with the encryption seed can include encrypting each of the fragments in the byte stream with the encryption seed, a first random number and a modulo of a second random number.

In another embodiment of the invention, a peer-to-peer data backup and archival network can be configured for securing fragments in a peer-to-peer data backup and archival network. The network can include a data backup and archival tool providing an interface for providing a file to be stored in the peer-to-peer backup and archival network. The network also can include peer hosts coupled to the tool. Finally, the network can include encryption and decryption logic coupled to the data backup and archival tool. The logic can include program code enabled to encrypt fragments in a byte stream from the file individually prior to the tool storing the encrypted fragments for the byte stream in different peer hosts in the peer-to-peer data backup and archival network. Optionally, the program code of the logic can be further enabled to re-order the fragments in an encrypted form of the byte stream prior to the tool storing the encrypted fragments for the byte stream in different peer hosts in the peer-to-peer data backup and archival network.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for securing fragments in a peer-to-peer data backup and archival network;

FIG. 2 is a schematic illustration of a peer-to-peer data backup and archival network configured for securing fragments directed for dispersal about the peer-to-peer data backup and archival network; and,

FIG. 3 is a flow chart illustrating a process for securing fragments in a peer-to-peer data backup and archival network.

### DETAILED DESCRIPTION OF THE INVENTION

Embodiments of the present invention provide a method, system and computer program product for securing fragments for dispersal across different storage media in a peer-to-peer data backup and archival network. In accordance with an embodiment of the present invention, a data backup set can be partitioned into fragments, encrypted and dispersed about different storage media in a peer-to-peer data backup and archival network. Specifically, fragments in a data stream to be archived can be individually encrypted before dispersal about the different storage media. Further, the fragments can be re-ordered in the byte stream. Upon retrieval, each of the fragments can be placed in an original position in the byte stream and individually decrypted. In this way, while stored in different storage media, each of the fragments can be highly secure through encryption and the information represented by the entire byte stream in proper order cannot be readily ascertained from the fragments stored in any one storage medium in the peer-to-peer data backup and archival network.

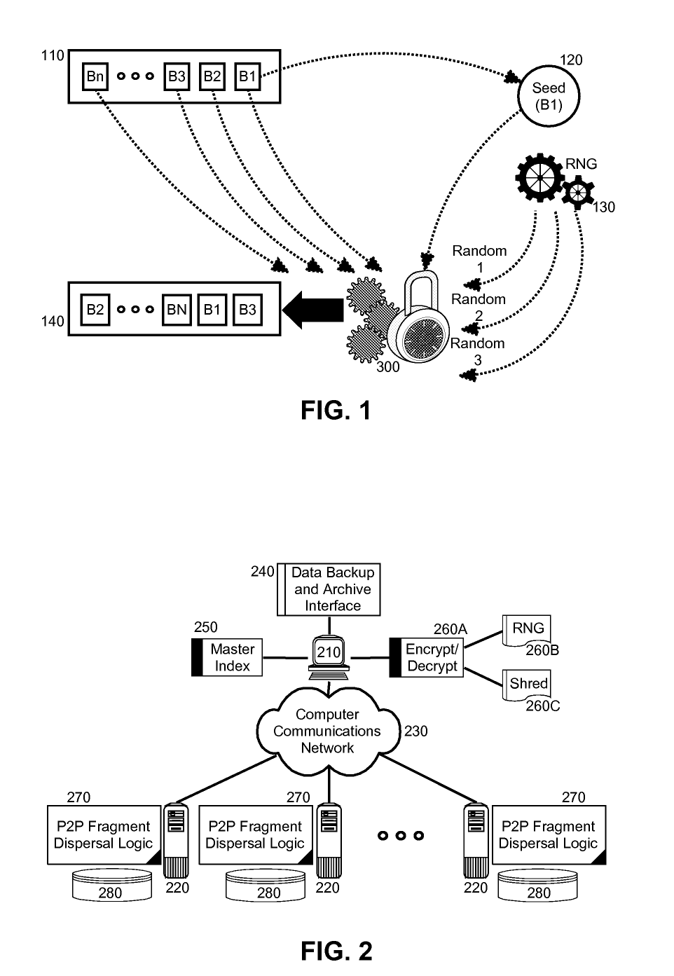

In further illustration, FIG. 1 is a pictorial illustration of a process for securing fragments in a peer-to-peer data backup and archival network. As shown in FIG. 1, an original byte stream 110 of multiple different fragments B1, B2, B3 . . . Bn can be provided for archival into a peer-to-peer data backup and archival network. The fragments B1, B2, B3 . . . Bn can include by way of example bytes or words or other such sub-denominations of a stream of data representative of a file. An encryption seed 120 can be computed from the first fragment B1 of the original byte stream 110 and provided to encryption process 300 for use in encrypting the fragments B1, B2, B3 . . . Bn. For each of the fragments B1, B2, B3 . . . Bn in the original byte stream 110, a two separate random numbers can be generated by random number generator 130 and provided to the encryption process 300.

The encryption process 300, for each of the fragments B1, B2, B3 . . . Bn in the original byte stream 110, can apply each of the encryption seed 120, the first random number and a modulo of the second random number in an encryption algorithm to each of the fragments B1, B2, B3 . . . Bn to generate an encrypted form of each of the fragments B1, B2, B3 . . . Bn. Thereafter, the positioning of each encrypted fragments in a resultant byte stream 140 can be modified according to a third random number produced by random number generator 130 combined with a splitting algorithm for packet stream encryption well-known in the art. The fragments B1, B2, B3 . . . Bn of the resultant byte stream 140 then can be dispersed to different storage media in the peer-to-peer data backup and archival network.

In yet further illustration, FIG. 2 is a schematic illustration of a peer-to-peer data backup and archival network configured for securing fragments directed for dispersal about the peer-to-peer data backup and archival network. The network can include multiple different peer hosts 220 communicatively coupled to one another in a peer-to-peer arrangement over computer communications network 230. Each of the peer hosts 220 can be coupled to a data storage medium 280 into which data fragments can be stored. Further, each of the peer hosts 220 can support the operation of peer-to-peer fragment dispersal logic 270.

The peer-to-peer fragment dispersal logic 270 can include program code enabled to respond to requests for fragment storage issued by data backup and archive tool 210. Further, the program code of the logic 270 can be enabled to report to master index 250 a location of a fragment when successfully stored in coupled data storage medium 280. Consequently, master index 250 can provide a centralized view of a location of all fragments of a file archived about the peer-to-peer network of peer hosts 220. In this regard, the master index 250 can be included as part of the data backup and archive tool 210 communicatively coupled to each of the peer hosts 220 in the peer-to-peer network of peer hosts 220 over computer communications network 230.

Optionally, the program code of the peer-to-peer fragment dispersal logic 270 can be enabled to forego the usage of master index 250. Instead, the location of a fragment can remain unknown over time amongst the peer hosts 220 in the peer-to-peer network of peer hosts 220. As such, the program code of the peer-to-peer fragment dispersal logic 270 can be enabled to broadcast a request for retrieval when required to the peer hosts 220 and the peer hosts 220 individually can respond to the broadcast request by returning any stored fragments within the individual ones of the peer hosts 220 in the peer-to-peer network of peer hosts 220.

The data backup and archive tool 210 can provide an interface 240 to external users through which files can be received for archive and retrieval into the peer-to-peer network. Even yet further, the data backup and archive tool 210 can include encryption and decryption logic 260A such that fragments for different files can be encrypted before injection into the peer-to-peer network and decrypted upon retrieval from the peer-to-peer network. Specifically, the encryption and decryption logic 260A can be enabled to encrypt individual fragments in a byte stream utilizing random numbers generated by coupled random number generator 260B. Yet further, a shred component 260C can be provided in connection with the encryption and decryption logic 260A and can be configured to reorder encrypted ones of the fragments in the byte stream utilizing a split algorithm supported by a random number generated by the random number generator 260B.

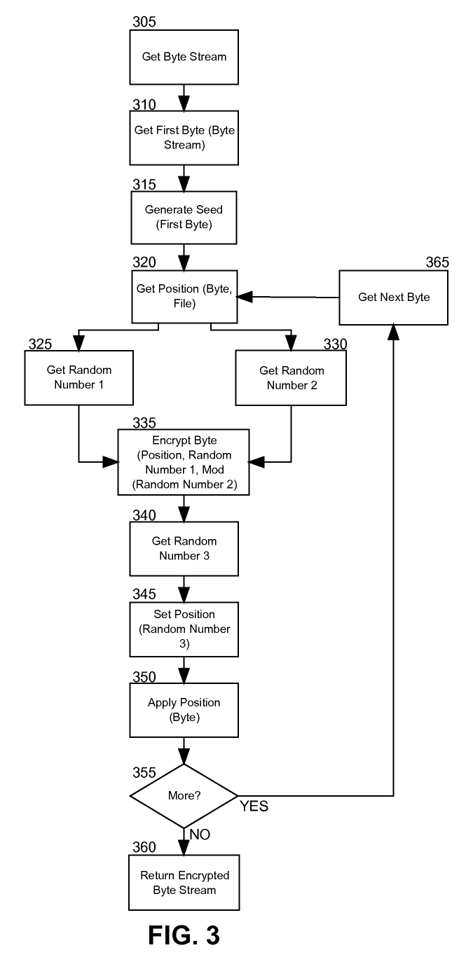

In even yet further illustration of the operation of the encryption and decryption logic 260A in combination with the random number generator 260B and shred component 260C, FIG. 3 is a flow chart illustrating a process for securing fragments in a peer-to-peer data backup and archival network. Beginning in block 305, an original byte stream can be received for encryption prior to dispersal about the peer-to-peer data backup and archival network. In block 310, a first fragment—for example a byte or word—in the original byte stream can be selected and in block 315 an encryption seed can be generated utilizing the selected byte. Thereafter, the process can continue through block 320.

In block 320, a position for the selected fragment can be determined within the original byte stream. In block 325 and 330, first and second random numbers can be generated. Thereafter, in block 335 the position, first random number, and a modulo of the second random number can be applied with the encryption seed to generate an encrypted form of the selected fragment. Yet further, a third random number can be generated in block 340 and in block 345 the third random number can be applied to a split algorithm along with the position in order to compute a random new position in an encrypted form of the original byte stream. In block 350 the computed new position can be applied to the selected fragment.

In decision block 355 it can be determined whether or not additional fragments remain to be processed in the original byte stream. If so, in block 365 a next fragment in the original byte stream can be selected for processing and the process can continue through block 320. In decision block 355, when no further fragments remain to be processed in the original byte stream, the encrypted and re-ordered form of the original byte stream can be returned for dispersal about the different storage media in the peer-to-peer data backup and archival network.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for securing fragments in a peer-to-peer data backup and archival network, the method comprising:
partitioning a file into multiple, different fragments in a byte stream for storage in a peer-to-peer data backup and archival network;
encrypting each of the fragments in the byte stream individually; and,
storing the encrypted fragments for the byte stream in different peer hosts in the peer-to-peer data backup and archival network.

2. The method of claim 1, further comprising re-ordering each of the fragments prior to storing the encrypted fragments in the different peer hosts.

3. The method of claim 1, wherein encrypting each of the fragments individually, comprises:
computing an encryption seed from a first fragment in the byte stream; and,
encrypting each of the fragments in the byte stream with the encryption seed.

4. The method of claim 2, wherein re-ordering each of the fragments prior to storing the encrypted fragments in the different peer hosts, comprises computing a random new position for each encrypted one of the fragments in an encrypted form of the byte stream according to a random number provided to a split algorithm.

5. The method of claim 3, wherein encrypting each of the fragments in the byte stream with the encryption seed, comprises encrypting each of the fragments in the byte stream with the encryption seed, a first random number and a modulo of a second random number.

6. A peer-to-peer data backup and archival network configured for securing fragments in a peer-to-peer data backup and archival network a, the network comprising:
a data backup and archival tool providing an interface for providing a file to be stored in the peer-to-peer backup and archival network;
a plurality of peer hosts coupled to the tool; and,
encryption and decryption logic coupled to the data backup and archival tool, the logic comprising program code enabled to encrypt fragments in a byte stream from the file individually prior to the tool storing the encrypted fragments for the byte stream in different peer hosts in the peer-to-peer data backup and archival network.

7. The network of claim 6, wherein the program code of the logic is further enabled to re-order the fragments in an encrypted form of the byte stream prior to the tool storing the encrypted fragments for the byte stream in different peer hosts in the peer-to-peer data backup and archival network.

8. A computer program product comprising a computer usable medium embodying computer usable program code for securing fragments in a peer-to-peer data backup and archival network, the computer program product comprising:
computer usable program code for partitioning a file into multiple, different fragments in a byte stream for storage in a peer-to-peer data backup and archival network;
computer usable program code for encrypting each of the fragments in the byte stream individually; and,
computer usable program code for storing the encrypted fragments for the byte stream in different peer hosts in the peer-to-peer data backup and archival network.

9. The computer program product of claim 8, further comprising computer usable program code for re-ordering each of the fragments prior to storing the encrypted fragments in the different peer hosts.

10. The computer program product of claim 8, wherein the computer usable program code for encrypting each of the fragments individually, comprises:
computer usable program code for computing an encryption seed from a first fragment in the byte stream; and,
computer usable program code for encrypting each of the fragments in the byte stream with the encryption seed.

11. The computer program product of claim 9, wherein the computer usable program code for re-ordering each of the fragments prior to storing the encrypted fragments in the different peer hosts, comprises computer usable program code for computing a random new position for each encrypted one of the fragments in an encrypted form of the byte stream according to a random number provided to a split algorithm.

12. The computer program product of claim 10, wherein the computer usable program code for encrypting each of the fragments in the byte stream with the encryption seed, comprises computer usable program code for encrypting each of the fragments in the byte stream with the encryption seed, a first random number and a modulo of a second random number.
